(19) United States
(12) Patent Application Publication
(10) Pub. No.: US 2021/0181596 A1
(43) Pub. Date: Jun. 17, 2021

(54) CAMERA FRONT COVER AND CAMERA THEREWITH

(71) Applicant: VIVOTEK INC., New Taipei City (TW)

(72) Inventors: Chih-Hao Chen, New Taipei City (TW); Ching-Ching Chen, New Taipei City (TW)

(21) Appl. No.: 17/109,158

(22) Filed: Dec. 2, 2020

(30) Foreign Application Priority Data
Dec. 12, 2019 (TW) 108145428

(51) Int. Cl. G03B 11/04; G03B 17/56

(52) U.S. Cl. CPC G03B 11/043; G03B 17/565

(57) ABSTRACT

A camera front cover includes an outer frame, a supporting ring inside the outer frame, an annular light-penetrable part, and a central light-penetrable part connected to and between the outer frame and the supporting ring. The central light-penetrable part is connected to the inner side of the supporting ring. The outer frame or the supporting ring includes two blocking structures, which extend parallel to an axial direction of the camera front cover to correspondingly block a fringe of the annular light-penetrable part or the central light-penetrable part correspondingly. A camera includes a device outer casing, an image-capturing device, and the camera front cover. The camera front cover is connected to the device outer casing to form an accommodating space in which the image-capturing device is disposed. A lens of the image-capturing device faces the central light-penetrable part and captures external images through the central light-penetrable part.

### BACKGROUND OF THE INVENTION

### 1. Field of the Invention

The present invention relates to a camera, and more particularly to a front cover of a camera.

### 2. Description of the Prior Art

Common surveillance cameras are usually equipped with a front cover disposed in front of the lens of the surveillance camera. The surveillance camera uses an auxiliary light source, such as infrared light. The front cover of some cameras will cover the lens and the light source at the same time to provide structural protection. Generally, in order to prevent the light from the light source from being directly reflected by the front cover to enter the lens, the front cover usually adopts a design to separate light-penetrable portions corresponding to the lens and the light source. If the camera has a plurality of light sources arranged around the lens, the light-penetrable portions of the front cover will include an outer light-penetrable portion and a central light-penetrable portion in principle, corresponding to the light sources and the lens respectively. The outer light-penetrable portion and the central light-penetrable portion are usually connected by a structural member. In order to take into account the feasibility of manufacturing the front cover, the outer light-penetrable portion and the central light-penetrable portion are usually fixed to the structural member only by glue. This structural design is usually difficult to provide a sufficient structural strength of the front cover in the axial direction to be able to withstand the impact of foreign objects for a long time. Furthermore, after a foreign object hits the front cover, the waterproof capacity of the front cover will probably be reduced or even fail.

### SUMMARY OF THE INVENTION

An objective of the invention is to provide a camera front cover, which uses two blocking structures disposed parallel to an axial direction of the camera front cover to enhance the axial structural strength of the camera front cover so that the waterproof capacity of the camera front cover can be maintained to a certain extent.

A camera front cover according to the invention has an axial direction and includes an outer frame, a supporting ring, an annular light-penetrable part, and a central light-penetrable part. The outer frame surrounds the axial direction and has a first inner connecting portion. The supporting ring surrounds the axial direction inside the outer frame. The supporting ring has an outer connecting portion and a second inner connecting portion opposite to the outer connecting portion. The annular light-penetrable part surrounds the axial direction and has a first outer fringe and an inner fringe. The annular light-penetrable part is connected to the first inner connecting portion through the first outer fringe. The annular light-penetrable part is connected to the outer connecting portion through the inner fringe. The central light-penetrable part has a second outer fringe. The central light-penetrable part is connected to the second inner connecting portion through the second outer fringe. Therein, one of the first inner connecting portion, the second inner connecting portion, and the outer connecting portion includes two blocking structures. The two blocking structures are disposed parallel to the axial direction to block the first outer fringe, the second outer fringe, or the inner fringe correspondingly.

Another objective of the invention is to provide a camera, which includes the above camera front cover. The camera front cover uses two blocking structures disposed parallel to the axial direction to enhance the axial structural strength of the camera front cover so that the waterproof capacity of the camera front cover can be maintained to a certain extent.

A camera according to the invention includes a device outer casing, a camera front cover, and an image-capturing device. The camera front cover is connected to the device outer casing to form an accommodating space. The image-capturing device is disposed in the accommodating space and includes a lens. The camera front cover has an axial direction and includes an outer frame, a supporting ring, an annular light-penetrable part, and a central light-penetrable part. The outer frame surrounds the axial direction and has a first inner connecting portion. The supporting ring surrounds the axial direction is disposed inside the outer frame. The supporting ring has an outer connecting portion and a second inner connecting portion opposite to the outer connecting portion. The annular light-penetrable part surrounds the axial direction and has a first outer fringe and an inner fringe. The annular light-penetrable part is connected to the first inner connecting portion through the first outer fringe. The annular light-penetrable part is connected to the outer connecting portion through the inner fringe. The central light-penetrable part has a second outer fringe. The central light-penetrable part is connected to the second inner connecting portion through the second outer fringe. The lens faces the central light-penetrable part and captures external images through the central light-penetrable part. Therein, one of the first inner connecting portion, the second inner connecting portion, and the outer connecting portion includes two blocking structures. The two blocking structures are disposed parallel to the axial direction to block the first outer fringe, the second outer fringe, or the inner fringe correspondingly.

Compared with the prior art, in the camera front cover according to the invention and the camera therewith, the two blocking structures are used to block the annular light-penetrable part or the central light-penetrable part correspondingly, for effectively structurally constrain the blocked portion of the annular light-penetrable part or the central light-penetrable part, so that the annular light-penetrable part or the central light-penetrable part can be effectively and firmly fixed in the axial direction. Thereby, the axial structural strength of the camera front cover can be improved and the waterproof capacity thereof can be maintained to a certain extent, which can effectively solve the problems in the prior art that the structural strength of the front cover is insufficient and it is difficult to maintain the waterproof capacity thereof.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a camera according to an embodiment.

FIG. 2 is a sectional view of the camera in FIG. 1 along the line X-X.

FIG. 3 is an enlarged view of a camera front cover of the camera in FIG. 2.

FIG. 4 is an exploded view of some components of the camera front cover in FIG. 2.

FIG. 5 is a schematic diagram illustrating a camera front cover according to an embodiment.

FIG. 6 is a sectional view of the camera front cover in FIG. 5 along the line Y-Y.

FIG. 7 is an exploded view of some components of the camera front cover in FIG. 5.

FIG. 8 is a schematic diagram illustrating a camera front cover according to an embodiment.

FIG. 9 is a sectional view of the camera front cover in FIG. 8 along the line Z-Z.

FIG. 10 is an exploded view of some components of the camera front cover in FIG. 8.

FIG. 11 is a sectional view of a camera front cover according to an embodiment.

### DETAILED DESCRIPTION

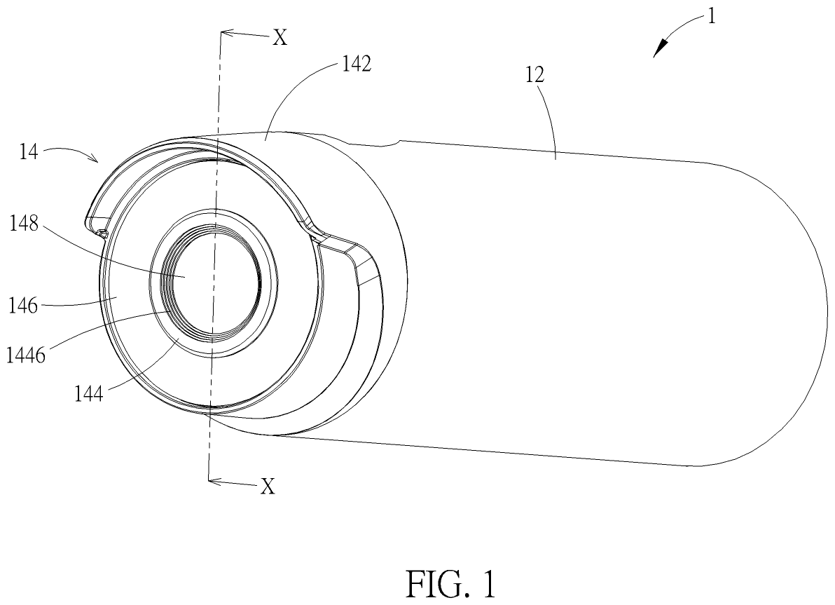

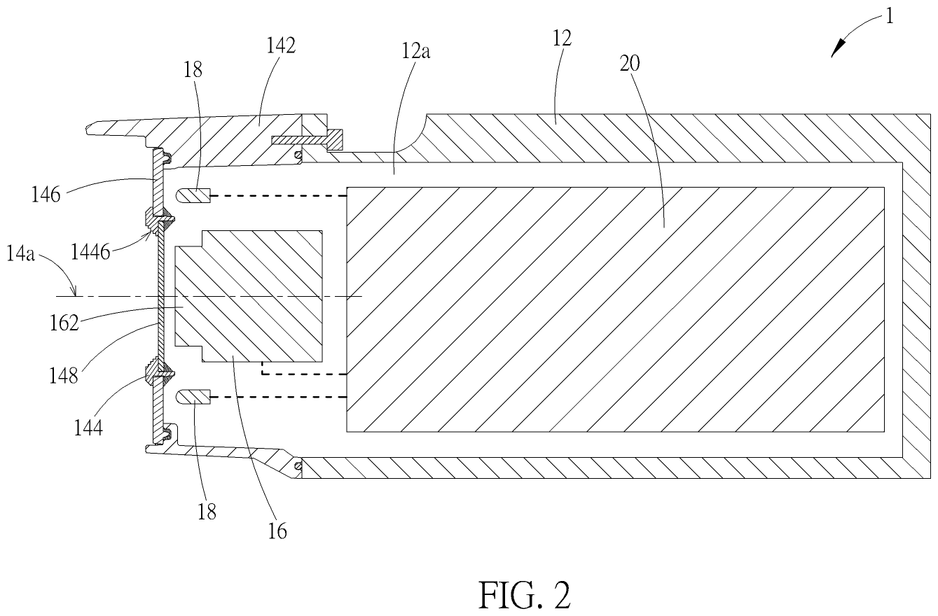

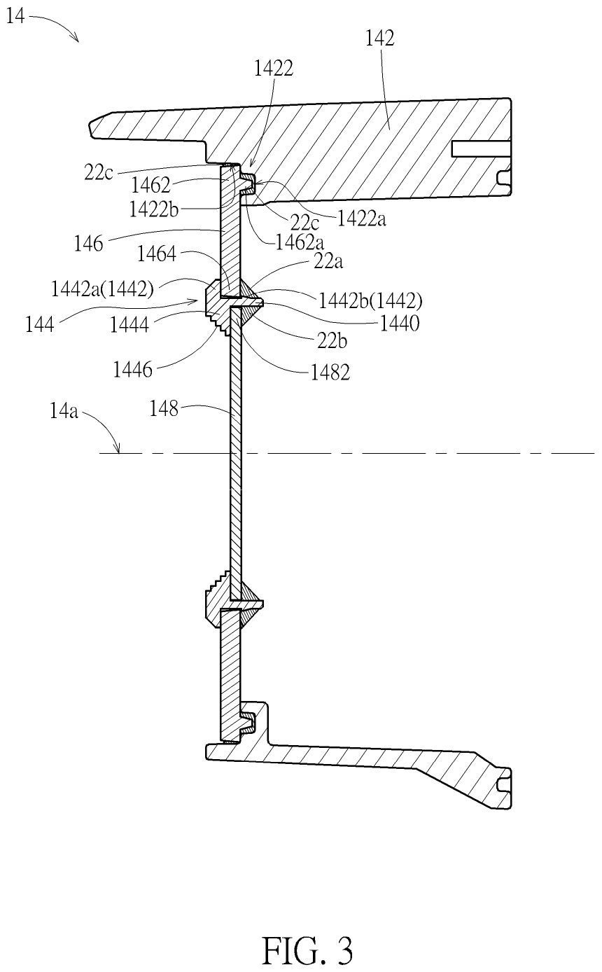

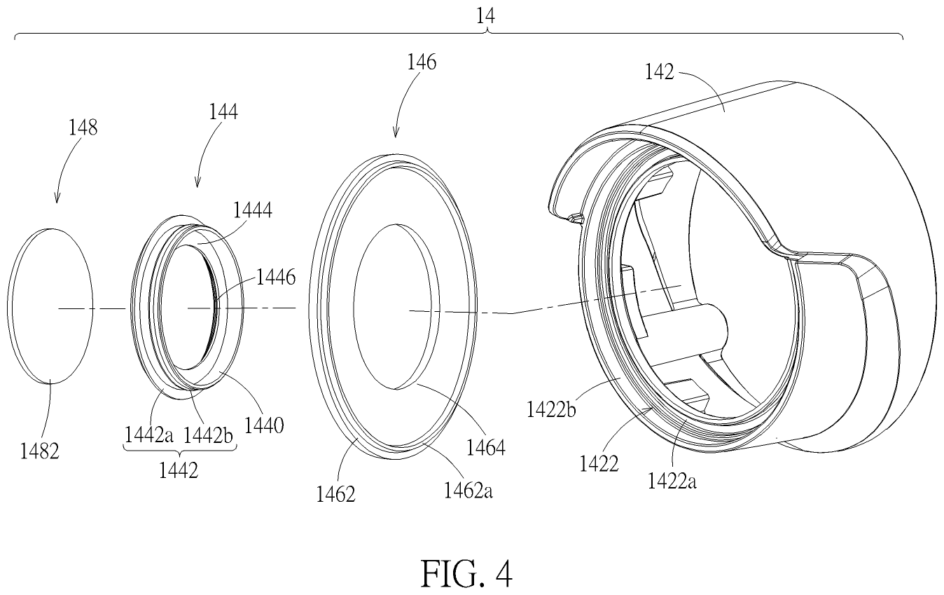

Please refer to FIG. 1 to FIG. 4. A camera 1 according to an embodiment includes a device outer casing 12, a camera front cover 14, an image-capturing device 16, a plurality of light sources 18, and a control module 20. The device outer casing 12 has an accommodating space 12a and is engaged with the camera front cover to accommodate other components. The control module 20 is electrically connected to the image-capturing device 16 and the plurality of light sources 18 (indicated by bold dashed lines) for controlling the operation of the image-capturing device 16 and the plurality of light sources 18. The image-capturing device 16 includes a lens 162. The lens 162 is toward the camera front cover 14.

In the embodiment, the camera front cover 14 has an axial direction 14a (indicated by a chain line in figures) and includes an outer frame 142, a supporting ring 144, an annular light-penetrable part 146, and a central light-penetrable part 148. The outer frame 142 (e.g. formed by, but not limited to, a metal part) surrounds the axial direction 14a and has a first inner connecting portion 1422. The supporting ring 144 surrounds the axial direction 14a inside the outer frame 142 and has an annular body 1440, an outer connecting portion 1442 outside the annular body 1440, and a second inner connecting portion 1444 inside the annular body 1440 opposite to the outer connecting portion 1442. The annular light-penetrable part 146 surrounds the axial direction 14a and has a first outer fringe 1462 and an inner fringe 1464. The annular light-penetrable part 146 is connected to the first inner connecting portion 1422 through the first outer fringe 1462. The annular light-penetrable part 146 is connected to the outer connecting portion 1442 through the inner fringe 1464. The central light-penetrable part 148 has a second outer fringe 1482. The central light-penetrable part 148 is connected to the second inner connecting portion 1444 through the second outer fringe 1482. The central light-penetrable part 148 faces the lens 162. The lens 162 can captures external images through the central light-penetrable part 148. The plurality of light sources 18 face the annular light-penetrable part 146. Light (e.g. but not limited to Infrared light) emitted by the light source 18 can pass through the annular light-penetrable part 146 to provide the main light or auxiliary light for the lens 162 to capture images.

In the embodiment, the outer connecting portion 1442 is a single structure and includes two blocking structures 1442a and 1442b that are arranged parallel to the axial direction 14a to block an inner fringe 1464 of the annular light-penetrable part 146. The blocking structures 1442a and 1442b protrude outward from the annular body 1440 radially (i.e. perpendicular to the axial direction 14a). The blocking structure 1442a is a blocker, and the blocking structure 1442b is a hook. The protruding height of the blocking structure 1442b from the annular body 1440 is much less than the protruding height of the blocking structure 1442a from the annular body 1440, which helps the inner fringe 1464 to get stuck between the blocking structures 1442a and 1442b from the blocking structure 1442b. In practice, the profile of the blocking structure 1442b (including the protruding height from the annular body 1440) can be decided according to the amount of interference between the blocking structure 1442b and the inner fringe 1464 and the material characteristics. For example, the blocking structure 1442b can be designed to be elastic. Then, there may be a relatively large amount of interference between the blocking structure 1442b and the inner fringe 1464, and the inner fringe 1464 can be smoothly inserted into the blocking structures 1442a and 1442b. Therein, the supporting ring 144 can be made of plastics. The profile of the blocking structure 1442b is not limited to the hook shape. For another example, the annular light-penetrable part 146 can have elasticity relative to the supporting ring 144. Then, there may be a relatively large amount of interference between the blocking structure 1442b and the inner fringe 1464, and the inner fringe 1464 can be smoothly inserted into the blocking structures 1442a and 1442b. Therein, the supporting ring 144 is a metal part, and the annular light-penetrable part 146 is made of plastics (e.g. but not limited to polycarbonate). Furthermore, the camera front cover 14 includes an adhesive 22a that joins the inner fringe 1464 of the annular light-penetrable part 146 with the blocking structure 1442b of the outer connecting portion 1442 in a fillet joint. The adhesive 22a covers the blocking structure 1442b, so that the adhesive 22a has the effect of reinforcing the blocking structure 1442b to block the inner fringe 1464. The adhesive 22a itself also has a sealing effect.

In the embodiment, the second inner connecting portion 1444 is a single structure and as a whole is a blocker, so as to block the second outer fringe 1482 of the central light-penetrable part 148 in the axial direction 14a. The camera front cover 14 includes an adhesive 22b that joins the second outer fringe 1482 of the central light-penetrable part 148 with the annular body 1440 in a fillet joint relative to the second inner connecting portion 1444. The adhesive 22b also has the effect of blocking the second outer fringe 1482. The adhesive 22b itself also has a sealing effect. Furthermore, the supporting ring 144 includes a light-eliminating structure 1446. The light-eliminating structure 1446 surrounds the central light-penetrable part 148 relative to the axial direction 14a to reduce or avoid light reflected toward the central light-penetrable part 148, which prevents light from being reflected to the lens 162 and affecting the quality of the images captured outward by the lens 162. In the embodiment, the light-eliminating structure 1446 is a stepped structure; however, it is not limited thereto in practice.

In the embodiment, the first inner connecting portion 1422 is a single structure and has an annular groove 1422a surrounding the axial direction 14a. Correspondingly, the first outer fringe 1462 of the annular light-penetrable part 146 has an annular protrusion 1462a that protrudes substantially parallel to the axial direction 14a. The annular protrusion 1462a is accommodated in the annular groove 1422a. An adhesive 22c fills the annular groove 1422a. The adhesive 22c has the effect of bonding the annular protrusion 1462a and the annular groove 1422a and also has a sealing effect. Furthermore, the first inner connecting portion 1422 has a joining surface 1422b that surrounds the axial direction 14a and is substantially parallel to the axial direction 14a. The adhesive 22c also fills the gap between the first outer fringe 1462 and the joining surface 1422b to connect the first outer fringe 1462 and the joining surface 1422b. In addition, in practice, the joining surface 1422b and/or a surface of first outer fringe 1462 opposite to the joining surface 1422b can thereon form threads or rough surfaces or other structures that can increase the contact area, and the adhesive 22c is also filled between them, which can enhance the bonding effect between the first inner connecting portion 1422 and the first outer fringe 1462.

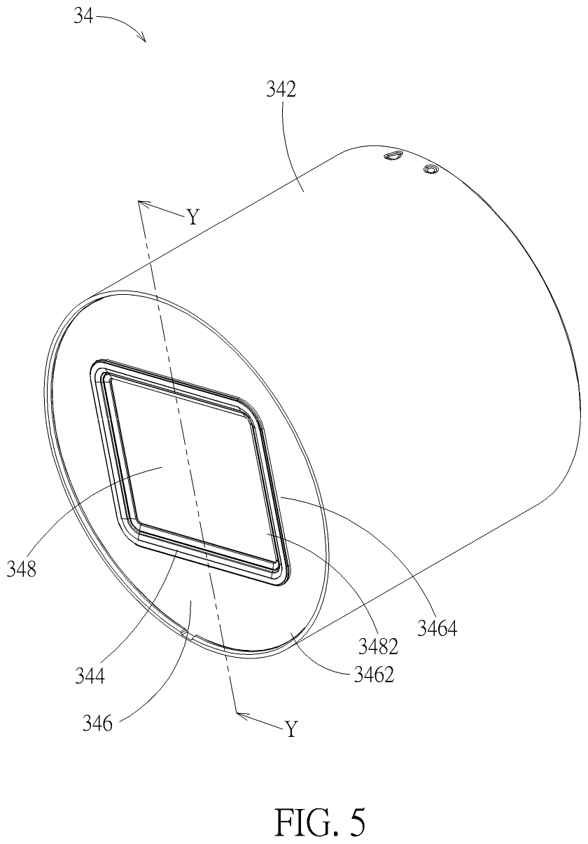

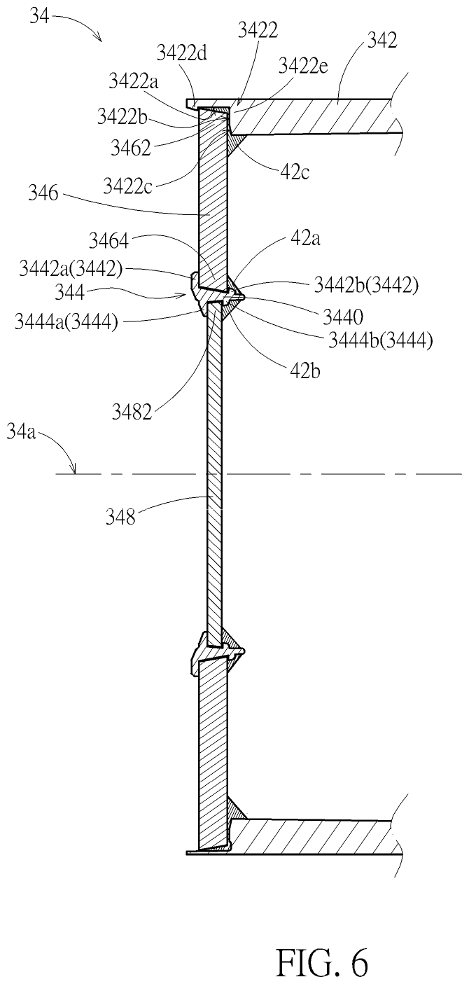

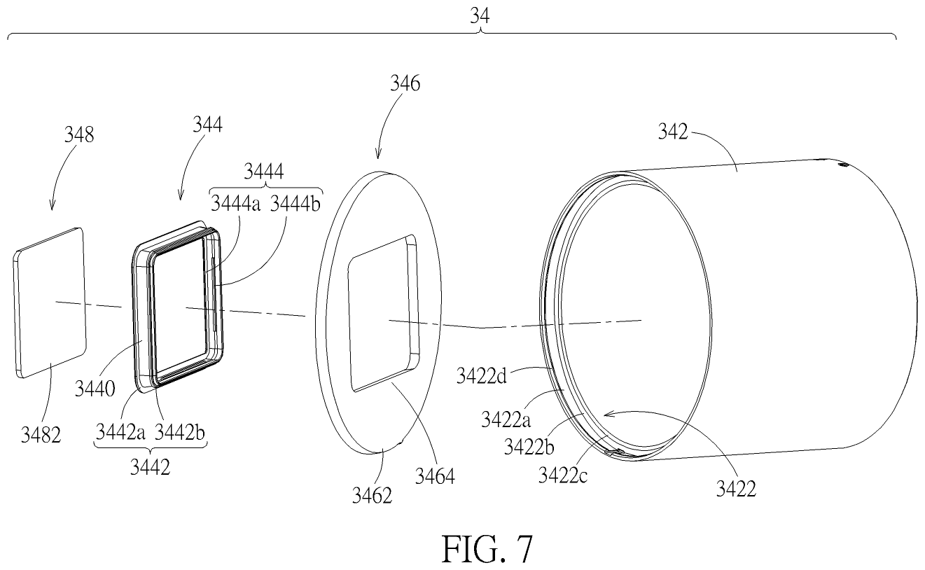

Please refer to FIG. 5 to FIG. 7. A camera front cover 34 according to an embodiment is logically similar in structure to the camera front cover 14. In practice, the camera front cover 34 can be appropriately modified in structure to replace the camera front cover 14 and be assembled to the camera 1. For other descriptions about the camera front cover 34, please refer to relevant descriptions of the camera front cover 14, which will not described in addition. In the embodiment, the camera front cover 34 has an axial direction 34a (indicated by a chain line in the figures) and includes an outer frame 342, a supporting ring 344, an annular light-penetrable part 346, and a central light-penetrable part 348. The outer frame 342 surrounds the axial direction 34a and has a first inner connecting portion 3422. The supporting ring 344 surrounds the axial direction 34a inside the outer frame 342 and has an annular body 3440, an outer connecting portion 3442 outside the annular body 3440, and a second inner connecting portion 3444 inside the annular body 3440 opposite to the outer connecting portion 3442. The annular light-penetrable part 346 surrounds the axial direction 34a and has a first outer fringe 3462 and an inner fringe 3464. The annular light-penetrable part 346 is connected to the first inner connecting portion 3422 through the first outer fringe 3462. The annular light-penetrable part 346 is connected to the outer connecting portion 3442 through the inner fringe 3464. The central light-penetrable part 348 has a second outer fringe 3482. The central light-penetrable part 348 is connected to the second inner connecting portion 3444 through the second outer fringe 3482.

In the embodiment, the outer connecting portion 3442 includes two blocking structures 3442a and 3442b that are disposed for blocking the inner fringe 3464 of the annular light-penetrable part 346. The blocking structures 3442a and 3442b protrude outward from the annular body 3440 radially (i.e. perpendicular to the axial direction 34a). The blocking structure 3442a is a blocker, and the blocking structure 3442b is a hook. The structural constraint of the blocking structures 3442a and 3442b on the inner fringe 3464 is logically equivalent to the structural constraint of the blocking structures 1442a and 1442b on the inner fringe 1464. For other descriptions about the blocking structures 3442a and 3442b, please refer to the relevant descriptions of the blocking structures 1442a and 1442b, which will not be described in addition. Furthermore, the camera front cover 34 has an adhesive 42a that joins the inner fringe 3464 of the annular light-penetrable part 346 with the blocking structure 3442b of the outer connecting portion 3442 in a fillet joint. The adhesive 42a covers the blocking structure 3442b, so that the adhesive 42a has the effect of reinforcing the blocking structure 3442b to block the inner fringe 3464. The adhesive 42a itself also has a sealing effect.

In the embodiment, the second inner connecting portion 3444 includes two blocking structures 3444a and 3444b that are arranged parallel to the axial direction 34a to block the second outer fringe 3482 of the central light-penetrable part 348. The structural constraint of the blocking structures 3444a and 3444b on the second outer fringe 3482 is logically equivalent to the structural constraint of the blocking structures 3442a and 3442b on the inner fringe 3464. For other descriptions about the blocking structures 3444a and 3444b, please refer to the relevant descriptions of the blocking structures 3442a and 3442b, which will not be described in addition. Therein, in practice, the central light-penetrable part 348 can have elasticity relative to the supporting ring 344 and is conducive to the structural design of the blocking structures 3444a and 3444b, which will not be described in addition. Furthermore, the camera front cover 14 includes an adhesive 42b that joins the second outer fringe 3482 of the central light-penetrable part 348 with the blocking structure 3444b in a fillet joint. The adhesive 42b covers the blocking structure 3444b, so that the adhesive 42b has the effect of reinforcing the blocking structure 3444b to block the second outer fringe 3482. The adhesive 42b itself also has a sealing effect.

In the embodiment, the first inner connecting portion 3422 has three joining surfaces 3422a, 3422b and 3422c that surround the axial direction 34a. The joining surface 3422a is substantially parallel to the axial direction 34a. The joining surface 3422b is substantially perpendicular to the axial direction 34a. The joining surface 3422c is a tapered surface (of which the normal direction is toward a side of the annular light-penetrable part 346 and forms an acute angle (not indicated in the figures) relative to the axial direction 34a). An adhesive 42c fills the gaps between the joining surfaces 3422a, 3422b and 3422c and the first outer fringe 3462 to connect the first outer fringe 3462 and the first inner connecting portion 3422. Furthermore, the adhesive 42c also protrudes out from the junction surface of the first outer fringe 3462 and the first inner connecting portion 3422; that is, the protruding portion of the adhesive 42c is equivalent to joining the first outer fringe 3462 and the outer frame 342 in a fillet joint. In practice, for an example, but not limited thereto, after the first outer fringe 3462 is placed on the first inner connecting portion 3422, the corner formed by the first outer fringe 3462 and the first inner connecting portion 3422 can be filled with the adhesive 42c. Then the adhesive 42c can flow into between the first outer fringe 3462 and the joining surface 3422c, between the first outer fringe 3462 and the joining surface 3422b, and between the first outer fringe 3462 and the joining surface 3422a in sequence by the capillary action.

Furthermore, in the embodiment, the first inner connecting portion 3422 includes a hook 3422d (at a distal end of the outer frame 342) that can hook the first outer fringe 3462. From another aspect, the portion of the first inner connecting portion 3422 corresponding to the hook 3422d can be taken as a blocking portion 3422e. The blocking portion 3422e and the hook 3422d blocks two opposite sides of the first outer fringe 3462 respectively. Thereby, the hook 3422d and the blocking portion 3422e also perform the aforementioned holding and blocking functions of the blocking structures 3442a and 3442b. The hook 3422d and the blocking portion 3422e can be taken as two blocking structures on the first inner connecting portion 3422. In addition, in the embodiment, the amount of structural interference between the hook 3422d and the first outer fringe 3462 is relatively small, and the annular light-penetrable part 146 is made of plastics, so that the outer frame 342 still can be made of metal.

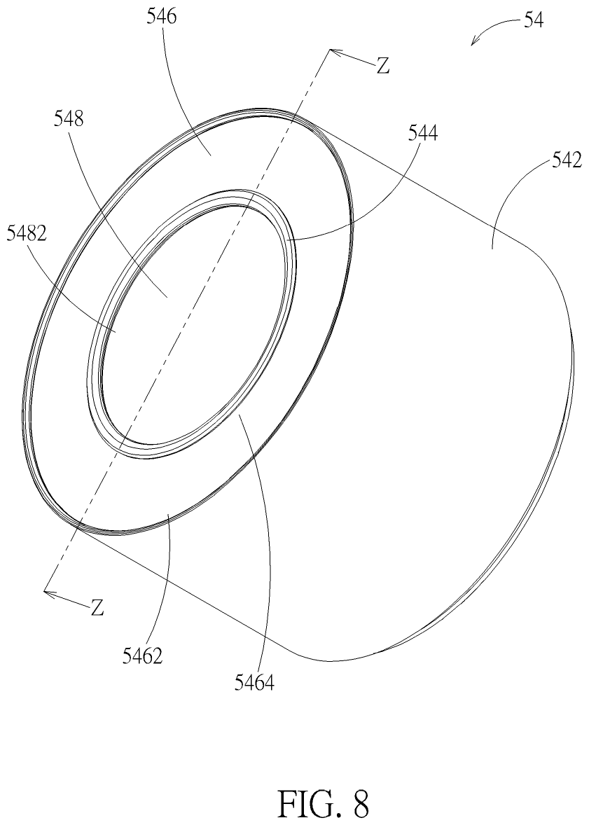

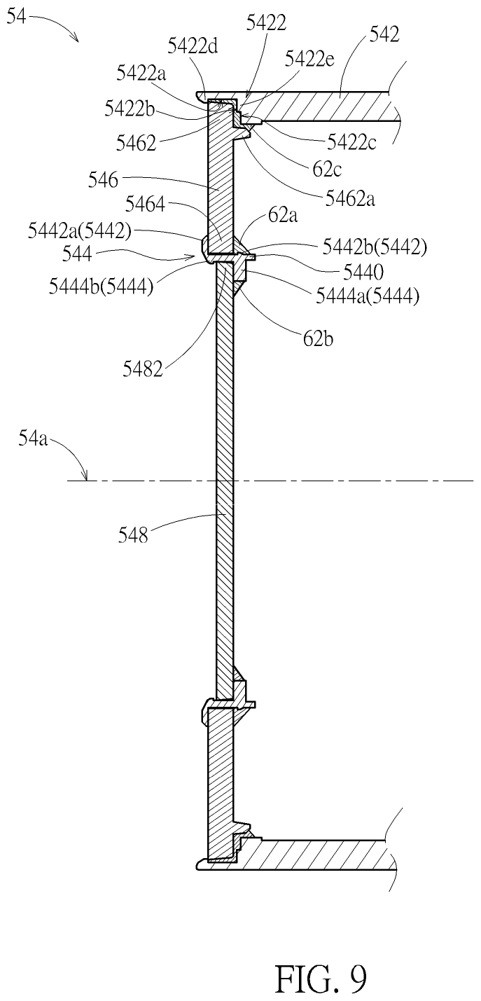

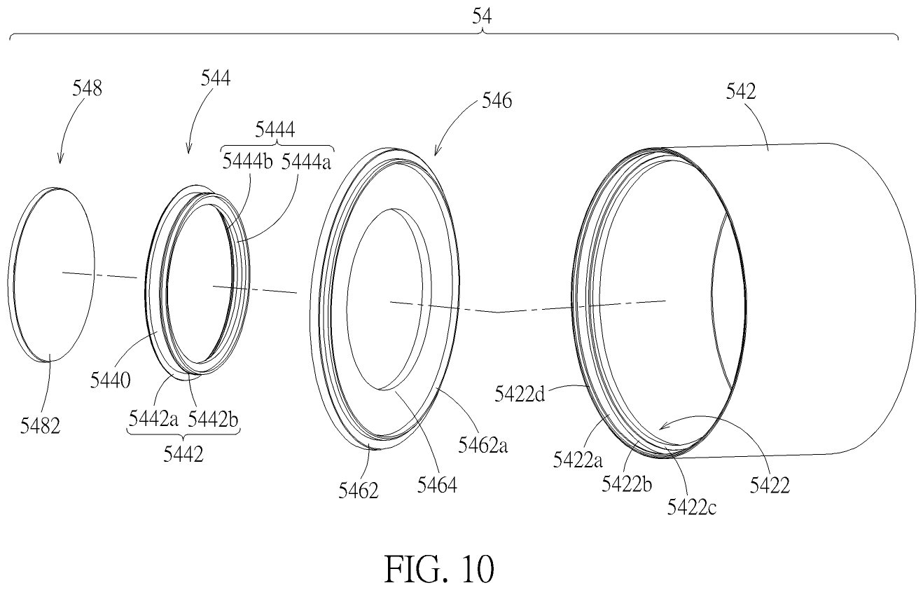

Please refer to FIG. 8 to FIG. 10. A camera front cover 54 according to an embodiment is structurally similar to the camera front cover 14. In practice, the camera front cover 54 can be appropriately modified in structure to replace the camera front cover 14 and be assembled to the camera 1. For other descriptions about the camera front cover 54, please refer to relevant descriptions of the camera front cover 14, which will not described in addition. In the embodiment, the camera front cover 54 has an axial direction 54a (indicated by chain line in the figures) and includes an outer frame 542, a supporting ring 544, an annular light-penetrable part 546, and a central light-penetrable part 548. The outer frame 542 surrounds the axial direction 54a and has a first inner connecting portion 5422. The supporting ring 544 surrounds the axial direction 54a inside the outer frame 542 and has an annular body 5440, an outer connecting portion 5442 outside the annular body 5440, and a second inner connecting portion 5444 inside the annular body 5440 opposite to the outer connecting portion 5442. The annular light-penetrable part 546 surrounds the axial direction 54a and has a first outer fringe 5462 and an inner fringe 5464. The annular light-penetrable part 546 is connected to the first inner connecting portion 5422 through the first outer fringe 5462. The annular light-penetrable part 546 is connected to the outer connecting portion 5442 through the inner fringe 5464. The central light-penetrable part 548 has a second outer fringe 5482. The central light-penetrable part 548 is connected to the second inner connecting portion 5444 through the second outer fringe 5482.

In the embodiment, the outer connecting portion 5442 includes two blocking structures 5442a and 5442b that are arranged parallel to the axial direction 54a to block the inner fringe 5464 of the annular light-penetrable part 546. The blocking structures 5442a and 5442b protrude outward from the annular body 5440 radially (i.e. perpendicular to the axial direction 54a). The blocking structure 5442a is a blocker; the blocking structure 5442b is a hook. The structural constraint of the blocking structures 5442a and 5442b on the inner fringe 5464 is logically equivalent to the structural constraint of the blocking structures 1442a and 1442b on the inner fringe 1464. For other descriptions about the blocking structures 5442a and 5442b, please refer to the relevant descriptions of the blocking structures 1442a and 1442b, which will not be described in addition. Furthermore, the camera front cover 54 has an adhesive 62a that joins the inner fringe 5464 of the annular light-penetrable part 546 with the blocking structure 5442b of the outer connecting portion 5442 in a fillet joint. The adhesive 62a covers the blocking structure 5442b, so that the adhesive 62a has the effect of reinforcing the blocking structure 5442b to block the inner fringe 5464. The adhesive 62a itself also has a sealing effect.

In the embodiment, the second inner connecting portion 5444 includes two blocking structures 5444a and 5444b that are arranged parallel to the axial direction 54a to block the second outer fringe 5482 of the central light-penetrable part 548. The structural constraint of the blocking structures 5444a and 5444b on the second outer fringe 5482 is logically equivalent to the structural constraint of the blocking structures 5442a and 5442b on the inner fringe 5464. For other descriptions about the blocking structures 5444a and 5444b, please refer to the relevant descriptions of the blocking structures 5442a and 5442b, which will not be described in addition. Furthermore, the camera front cover 54 includes an adhesive 62b that joins the second outer fringe 5482 of the central light-penetrable part 548 with the blocking structure 5444a in a fillet joint. The adhesive 62b itself also has a sealing effect. In practice, an adhesive can also be filled at the blocking structure 5444b, which can simultaneously enhance the effect of the blocking structure 5442b blocking the second outer fringe 5482 and provide a sealing effect.

In the embodiment, the first inner connecting portion 5422 has two joining surfaces 5422a and 5422b that surround the axial direction 54a. The joining surface 5422a is substantially parallel to the axial direction 54a. The joining surface 5422b is substantially perpendicular to the axial direction 54a. An adhesive 62c fills the gap between the joining surfaces 5422a and 5422b and the first outer fringe 5462 to connect the first outer fringe 5462 and the first inner connecting portion 5422 (or the joining surfaces 5422a and 5422b thereof). Furthermore, the joining surface 5422b has an offset structure 5422c. The adhesive 62c also fills the offset structure 5422c. The offset structure 5422c enhances the effect of the adhesive 62c bonding the first outer fringe 5462 with the first inner connecting portion 5422 by accommodating the adhesive 62c. Furthermore, in the embodiment, the first outer fringe 5462 has an annular protrusion 5462a. The annular protrusion 5462a protrudes substantially parallel to the axial direction 54a inside the outer frame 542 and is adjacent to the first inner connecting portion 5422. The adhesive 62c also fills the gap between the annular protrusion 5462a and the first inner connecting portion 5422. The annular protrusion 5462a not only increases the structural constraints between the annular light-penetrable part 546 and the outer frame 542, but also increases the area where the first outer fringe 5462 and the first inner connecting portion 5422 are joined through the adhesive 62c, which enhances the bonding effect. Furthermore, in another embodiment, a thread-like structure can be disposed on the first inner connecting portion 5422 and/or the first outer fringe 5462 where the both are connected. The bonding area of the adhesive 62C can be increased by the thread-like structure for enhancing the bonding effect.

Furthermore, in the embodiment, the first inner connecting portion 5422 includes a hook 5422d (at an end of the outer frame 542) capable of hooking the first outer fringe 5462. From another aspect, the portion of the first inner connecting portion 5422 opposite to the hook 5422d can be taken as a blocking portion 5422e. The blocking portion 5422e and the hook 5422d blocks two opposite sides of the first outer fringe 5462 respectively. Thereby, the hook 5422d and the blocking portion 5422e also can perform the holding and blocking functions of the aforementioned blocking structures 5442a and 5442b, so the hook 5422d and the blocking portion 5422e can be taken as two blocking structures disposed on the first inner connecting portion 5422. In addition, in the embodiment, the amount of structural interference between the hook 5422d and first outer fringe 5462 is relatively small, or the annular light-penetrable part 546 is made of plastics, so that the outer frame 542 still can be made of metal.

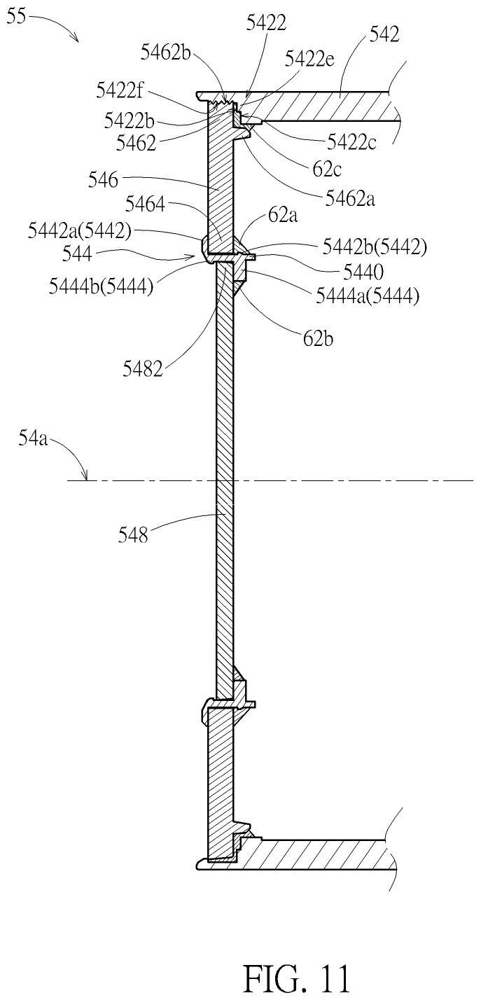

In the above embodiments, the annular light-penetrable parts 146, 346 and 546 and the outer frames 142, 342 and 542 are joined by adhesives and holding structures; however, in practice, they can be joined by other structures. Please refer to FIG. 11. A camera front cover 55 according to an embodiment is structurally similar to the camera front cover 54 and uses the reference numbers of the camera front cover 54. For other descriptions about the camera front cover 55, please refer to relevant descriptions of the camera front cover 54, which will not described in addition. A main difference between the camera front cover 55 and the camera front cover 54 is that in the camera front cover 55, the first inner connecting portion 5422 of the outer frame 542 has a thread 5422f (e.g. an internal thread), the first outer fringe 5462 of the annular light-penetrable part 546 has a mating thread 5462b (e.g. an external thread), and the first outer fringe 5462 and the first inner connecting portion 5422 are engaged with each other through the thread 5422f and the thread 5462b. In addition, in practice, if the material of the annular light-penetrable part 546 is relatively soft to that of the outer frame 542, it is practicable not to form the thread 5462b on the first outer fringe 5462 in advance. By directly screwing the first outer fringe 5462 onto the thread 5422f, the thread 5422f can directly mark the thread 5462b on the first outer fringe 5462.

In addition, in the camera front covers 14 and 34, a fastening ring can be used to engaged with the outer frames 142 and 342 (e.g. through threaded structures) for clamping the annular light-penetrable parts 146 and 346. Similarly, the camera front cover 55 can be modified appropriately to remove the thread 5422f and the thread 5462b and use a fastening ring to engage with the outer frame 542 through threaded structures for clamping the annular light-penetrable part 546.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A camera front cover, having an axial direction and comprising:
an outer frame, surrounding the axial direction, the outer frame having a first inner connecting portion;
a supporting ring, surrounding the axial direction inside the outer frame, the supporting ring having an outer connecting portion and a second inner connecting portion opposite to the outer connecting portion;
an annular light-penetrable part, surrounding the axial direction, the annular light-penetrable part having a first outer fringe and an inner fringe, the annular light-penetrable part being connected to the first inner connecting portion through the first outer fringe, the annular light-penetrable part being connected to the outer connecting portion through the inner fringe; and
a central light-penetrable part, having a second outer fringe, the central light-penetrable part being connected to the second inner connecting portion through the second outer fringe;
wherein one of the first inner connecting portion, the second inner connecting portion, and the outer connecting portion comprises two blocking structures, disposed parallel to the axial direction to block the first outer fringe, the second outer fringe, or the inner fringe correspondingly.

2. The camera front cover according to claim 1, wherein the first inner connecting portion has an annular groove, the annular groove surrounds the axial direction, the first outer fringe has an annular protrusion, the annular protrusion protrudes parallel to the axial direction, the annular protrusion is accommodated in the annular groove, and an adhesive fills the annular groove.

3. The camera front cover according to claim 1, wherein the first inner connecting portion has a joining surface, the joining surface surrounds the axial direction, the joining surface is parallel to the axial direction, is perpendicular to the axial direction, or is a tapered surface, and the first outer fringe is connected to the joining surface.

4. The camera front cover according to claim 3, wherein the joining surface has an offset structure, the first outer fringe is adhered to the joining surface by an adhesive, and the adhesive fills the offset structure.

5. The camera front cover according to claim 4, wherein the first outer fringe has an annular protrusion, the annular protrusion protrudes parallel to the axial direction, is located inside the outer frame, and is adjacent to the first inner connecting portion, and the adhesive fills a gap between the annular protrusion and the first inner connecting portion.

6. The camera front cover according to claim 1, wherein the two blocking structures comprise a blocker and a hook.

7. The camera front cover according to claim 1, further comprising an adhesive, wherein the adhesive joins the first inner connecting portion with the first outer fringe, the inner fringe with the outer connecting portion, or the second inner connecting portion with the second outer fringe in a fillet joint.

8. The camera front cover according to claim 1, wherein the supporting ring has a light-eliminating structure, and the light-eliminating structure surrounds the central light-penetrable part relative to the axial direction for reducing light reflected toward the central light-penetrable part.

9. The camera front cover according to claim 8, wherein the light-eliminating structure is a stepped structure.

10. The camera front cover according to claim 1, wherein the first inner connecting portion or the first outer fringe has a thread, the thread surrounds the axial direction, and the first outer fringe and the first inner connecting portion are engaged with each other through the thread.

11. A camera, comprising:
a device outer casing;
a camera front cover, connected to the device outer casing to form an accommodating space, the camera front cover having an axial direction and comprising:
an outer frame, surrounding the axial direction, the outer frame having a first inner connecting portion;
a supporting ring, surrounding the axial direction inside the outer frame, the supporting ring having an outer connecting portion and a second inner connecting portion opposite to the outer connecting portion;
an annular light-penetrable part, surrounding the axial direction, the annular light-penetrable part having a first outer fringe and an inner fringe, the annular light-penetrable part being connected to the first inner connecting portion through the first outer fringe, the annular light-penetrable part being connected to the outer connecting portion through the inner fringe; and
a central light-penetrable part, having a second outer fringe, the central light-penetrable part being connected to the second inner connecting portion through the second outer fringe, one of the first inner connecting portion, the second inner connecting portion, and the outer connecting portion comprising two blocking structures, disposed parallel to the axial direction to block the first outer fringe, the second outer fringe, or the inner fringe correspondingly; and
an image-capturing device, disposed in the accommodating space, the image-capturing device comprising a lens, the lens facing the central light-penetrable part, the lens capturing external images through the central light-penetrable part.

12. The camera according to claim 11, wherein the first inner connecting portion has an annular groove, the annular groove surrounds the axial direction, the first outer fringe has an annular protrusion, the annular protrusion protrudes parallel to the axial direction, the annular protrusion is accommodated in the annular groove, and an adhesive fills the annular groove.

13. The camera according to claim 11, wherein the first inner connecting portion has a joining surface, the joining surface surrounds the axial direction, the joining surface is parallel to the axial direction, is perpendicular to the axial direction, or is a tapered surface, and the first outer fringe is connected to the joining surface.

14. The camera according to claim 13, wherein the joining surface has an offset structure, the first outer fringe is adhered to the joining surface by an adhesive, and the adhesive fills the offset structure.

15. The camera according to claim 14, wherein the first outer fringe has an annular protrusion, the annular protrusion protrudes parallel to the axial direction, is located inside the outer frame, and is adjacent to the first inner connecting portion, and the adhesive fills a gap between the annular protrusion and the first inner connecting portion.

16. The camera according to claim 11, wherein the two blocking structures comprise a blocker and a hook.

17. The camera according to claim 11, wherein the camera front cover comprises an adhesive, and the adhesive joins the first inner connecting portion with the first outer fringe, the inner fringe with the outer connecting portion, or the second inner connecting portion with the second outer fringe in a fillet joint.

18. The camera according to claim 11, wherein the supporting ring has a light-eliminating structure, and the light-eliminating structure surrounds the central light-penetrable part relative to the axial direction for avoiding from reflecting light toward the central light-penetrable part.

19. The camera according to claim 18, wherein the light-eliminating structure is a stepped structure.

20. The camera according to claim 11, wherein the first inner connecting portion or the first outer fringe has a thread, the thread surrounds the axial direction, and the first outer fringe and the first inner connecting portion are engaged with each other through the thread.
